(19) United States
(12) Patent Application Publication
(10) Pub. No.: US 2012/0106555 A1
(43) Pub. Date: May 3, 2012

(54) LOW LATENCY CARRIER CLASS SWITCH-ROUTER

(75) Inventor: Ashwin Gumaste, Mumbai (IN)

(73) Assignee: INDIAN INSTITUTE OF TECHNOLOGY BOMBAY, Mumbai (IN)

(21) Appl. No.: 13/206,507

(22) Filed: Aug. 10, 2011

Related U.S. Application Data
(60) Provisional application No. 61/409,110, filed on Nov. 1, 2010.

(30) Foreign Application Priority Data
Jun. 6, 2011 (IN) 1650/MUM/2011

(51) Int. Cl. H04L 12/28; H04L 12/56

(52) U.S. Cl. 370/395.53; 370/389

(57) ABSTRACT

Systems and techniques for processing and forwarding packets are described. During operation, a system can receive a packet on an input port. Next, the system can identify a set of bits in the packet that represents a route from a source node to a destination node in an n-ary tree. The system can then determine an output port based on a subset of the set of bits. Next, the system can determine whether the output port is free. If the output port is not free, the system can use a contention resolution mechanism to store the packet in an on-chip memory or an off-chip memory based on space availability and the packet's priority. If the output port is free, the system can send the packet through the output port.

### RELATED APPLICATION

This application claims priority to U.S. Provisional Application No. 61/409,110, Attorney Docket Number IITB10-0001P, entitled “A Low Latency Carrier Class Switch-Router,” by inventor Ashwin Gumaste, filed 1 Nov. 2010, the contents of which are incorporated by reference herein.

This application claims priority to Indian Patent Application No. 1650/MUM/2011, entitled “A Low Latency Carrier Class Switch-Router,” by inventor Ashwin Gumaste, filed 6 Jun. 2011, the contents of which are incorporated by reference herein.

### BACKGROUND

1. Technical Field

This disclosure relates to computer networking. More specifically, this disclosure relates to a low latency carrier class switch-router.

2. Related Art

The insatiable demand for bandwidth and the ever increasing size and complexity of computer networks has created a strong need for switches and/or routers that are capable of performing switching and/or routing functions with low latencies.

It is generally desirable to decrease the switching and/or routing latency, cost, and power consumption of switches and/or routers. Some approaches decrease switching and/or routing latency by increasing the complexity and/or the speed at which the circuits operate. Unfortunately, these approaches increase the cost and the power consumption of the switches and/or routers.

### SUMMARY

Some embodiments described in this disclosure provide methods and apparatuses for processing and forwarding packets. Specifically, some embodiments provide a switch-router that can include one or more of: (1) input ports to receive packets, (2) output ports to send packets, (3) a port determining mechanism to determine an output port for a packet, (4) a first memory and a second memory, wherein the first memory has a lower latency than the second memory, and (5) a contention resolution mechanism.

In some embodiments, the contention resolution mechanism can be configured to: (1) provide the packet to the output port if the output port is free, (2) in response to determining that the output port is busy and space is available in the first memory to store the packet, store the packet in the first memory, (3) in response to determining that the output port is busy, space is not available in the first memory to store the packet, and a lower-priority packet having a lower priority than the packet is currently stored in the first memory, move the lower-priority packet to the second memory, and store the packet in the first memory, (4) in response to determining that the output port is busy, space is not available in the first memory to store the packet, and a lower-priority packet having a lower priority than the packet is not currently stored in the first memory, store the packet in the second memory, (5) in response to determining that the output port is free and the first memory does not contain any packets, provide the packet, if currently stored in the second memory, to the output port, and (6) in response to determining that the output port is not free and the first memory has space for storing the packet, move the packet, if currently stored in the second memory, to the first memory.

In some embodiments, the port determining mechanism can be configured to: (1) identify a set of bits in the packet, wherein the set of bits represents a route from a source node to a destination node in an n-ary tree, and (2) determine the output port based on a subset of the set of bits.

In some embodiments, the switch-router has N input ports and N output ports, wherein the second memory comprises N×N memory blocks, wherein each memory block is associated with an input port and an output port, and wherein each memory block includes buffers for storing packets that are received on the input port associated with the memory block and which are destined for the output port associated with the memory block.

In some embodiments, the packet is an Ethernet packet, wherein the set of bits are stored in one or more VLAN (Virtual Local Area Network) tags, and wherein a location of the subset of the set of bits in the one or more VLAN tags is encoded using three-bit QoS (quality of service) fields and one-bit CFI (canonical form identifier) fields in the one or more VLAN tags.

In some embodiments, the packet is an MPLS (Multi-Protocol Label Switching) packet, wherein the set of bits are stored in one or more MPLS labels, and wherein a location of the subset of the set of bits in the one or more MPLS labels is encoded in specific portion of each MPLS label.

In some embodiments, the switch-router can include: (1) a format-determining mechanism configured to determine whether the packet conforms to a format that includes the set of bits that represents the route from the source node to the destination node in the n-ary tree, and (2) an adding mechanism configured to add the set of bits if the packet does not conform to the format.

### BRIEF DESCRIPTION OF THE FIGURES

FIG. 1A illustrates how a binary address can be determined for a node in a binary tree in accordance with some embodiments described in this disclosure.

FIG. 1B illustrates how a binary route can be determined based on the source and destination binary addresses in accordance with some embodiments described in this disclosure.

FIG. 1C illustrates how a packet can be routed in a binary tree based on a binary route in accordance with some embodiments described in this disclosure.

FIG. 2 illustrates how a packet can be forwarded within a network using binary information stored in the VLAN tags in accordance with some embodiments described in this disclosure.

FIG. 3 illustrates an example of a packet format in accordance with some embodiments described in this disclosure.

FIG. 4 illustrates a system, e.g., a switch-router, in accordance with some embodiments described in this disclosure.

FIG. 5 illustrates a port determining logic block in accordance with some embodiments described in this disclosure.

FIG. 6A illustrates how buffers for ports can be stored in a lumped table in accordance with some embodiments described in this disclosure.

FIG. 6B illustrates a memory management unit (MMU) that can be used to access the lumped memory buffer in accordance with some embodiments described in this disclosure.

FIG. 7A illustrates an apparatus in accordance with some embodiments described in this disclosure.

FIG. 7B illustrates an apparatus in accordance with some embodiments described in this disclosure.

FIG. 8A presents a flowchart that illustrates a process for forwarding packet in accordance with some embodiments described in this disclosure.

FIG. 8B presents a flowchart that illustrates a process for resolving contentions in accordance with some embodiments described in this disclosure.

FIG. 9 illustrates an apparatus in accordance with some embodiments described in this disclosure.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

### Switches and Routers

Computer networking is typically accomplished using a layered software architecture, which is often referred to as a networking stack. Each layer is usually associated with a set of protocols which define the rules and conventions for processing packets in that layer. Each lower layer performs a service for the layer immediately above it to help with processing packets. The Open Systems Interconnection (OSI) model defines a seven layered network stack.

At a source node, each layer typically adds a header as the payload moves from higher layers to lower layers through the source node's networking stack. A destination node typically performs the reverse process by processing and removing headers of each layer as the payload moves from the lowest layer to the highest layer at the destination node.

A network can include nodes that are coupled by links in a regular or arbitrary network topology. A networking stack may include a link layer (layer 2 in the OSI model) and a network layer (layer 3 in the OSI model). The link layer (e.g., Ethernet) may be designed to communicate packets between nodes that are coupled by a link, and the network layer (e.g., Internet Protocol or IP for short) may be designed to communicate packets between any two nodes within a network.

A device that makes forwarding decisions based on information associated with the link layer is sometimes called a switch. A device that makes forwarding decisions based on information associated with the network layer is sometimes called a router. The term “switch-router” is used in this disclosure to refer to a device that is capable of making forwarding decisions based on information associated with the link layer and/or the network layer. Some embodiments described in this disclosure provide a low latency carrier class switch-router.

Unless otherwise stated, the term “IP” refers to both “IPv4” and “IPv6” in this disclosure. The use of the term “frame” is not intended to limit the present invention to the link layer, and the use of the term “packet” is not intended to limit the present invention to the network layer. In this disclosure, the terms “frame” and “packet” generally refer to a group of bits, and have been used interchangeably. Additionally, the terms “frame” or “packet” may be substituted with other terms that refer to a group of bits, such as “cell” or “datagram.”

### N-ary Trees and Source Routing

Some embodiments of the present invention abstract a network to an n-ary tree. A network topology, e.g., a physical ring, mesh, star, tree, or bus, can be converted to a tree. A tree can then be converted into an n-ary tree which may require the addition of dummy (virtual) nodes.

For example, when n=2, every physical node in the tree whose degree of connectivity is greater than 1×2 (i.e., one input and two outputs), can be replaced by a cluster of virtual and physical (actual) binary nodes. Note that binary nodes are nodes whose degree of connectivity is 1×2. The resulting graph can then be converted to a binary tree by disconnecting loops using a breadth first search algorithm, beginning from a root node (which may correspond to a gateway device).

A similar technique can be used to convert a network into an n-ary tree when n>2. For the sake of clarity and ease of discourse, some embodiments of the present invention have been described in the context of a binary tree (i.e., an n-ary tree in which n=2). These examples and techniques can be extended to the case when n>2. For example, when n>2, every physical node in the tree whose degree of connectivity is greater than 1×n (i.e., one input and n outputs), can be replaced by a cluster of virtual and physical (actual) n-ary nodes. Note that n-ary nodes are nodes that has one input and up to n outputs, i.e., whose degree of connectivity is 1×1, 1×2, . . . , or 1×n. The resulting graph can then be converted to an n-ary tree by disconnecting loops using a breadth first search algorithm, beginning from a root node.

Once an n-ary tree has been determined, source routing can be performed on the n-ary tree. The n-ary address of a node in an n-ary tree is allocated according to the node's position with respect to the root of the n-ary tree. Specifically, the address of a node can encode the n-ary route traversed from the root of the tree to the node.

For example, suppose a binary tree is illustrated on a sheet and a route from the root to a node is drawn along the binary tree. The root can be given the address “0.” Next, a “0” can be appended whenever a “right” turn is taken in the binary route, and a “1” can be appended whenever a “left” turn is taken in the binary route. The resulting string of zeros and ones can be the binary address for the node. When n>2, each outgoing edge in a node can be represented using multiple bits, and the system can append the bits associated with an edge when the edge is taken in the n-ary route.

A source node can compute the route to a destination node if it knows its own n-ary address and the destination node's n-ary address. The n-ary route from the source node to the destination node can be represented as a bit string. The n-ary address of the source and/or destination node and the bit string that represents the n-ary route from the source node to the destination node can be stored in one or more fields of an Ethernet packet. For example, the source and/or destination address and the n-ary route can be carried in one or more VLAN (Virtual Local Area Network) tags in the Ethernet packet. In some embodiments, the source and/or destination address and the n-ary route can be carried in one or more MPLS labels of an MPLS or MPLS-TP packet.

Embodiments of the present invention can lead to significant cost-savings by facilitating multiple layer functions in a device. Further, embodiments of the present invention can lead to simple network architectures due to the homogeneity of the solution across the network. Additionally, embodiments of the present invention can reduce the energy consumption of the network due to the absence of a lookup table, because, once the n-ary address and/or routing information has been added to the packet, the decision to forward a packet at a node in the network depends entirely on the n-ary address and/or routing information.

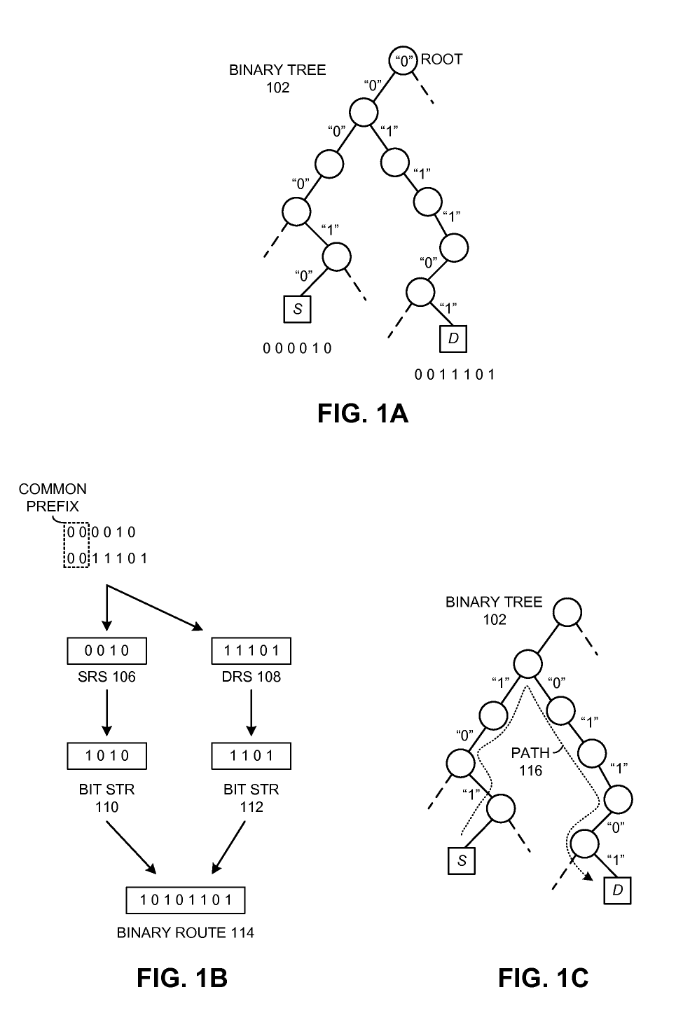

FIGS. 1A-1C illustrate how source routing in a binary tree can be used to forward packets in a network in accordance with some embodiments described in this disclosure.

FIG. 1A illustrates how a binary address can be determined for a node in a binary tree in accordance with some embodiments described in this disclosure. As shown in FIG. 1A, binary tree 102 can be visually represented by a set of nodes that are connected by edges. The binary address of a node can be determined by starting at the root node of binary tree 102 (which can be given the address “0”), and appending a “0” whenever a right turn is taken in the binary tree, and appending a “1” whenever a left turn is taken in the binary tree. Using this approach, the address of nodes S and D are “000010” and “0011101,” respectively.

FIG. 1B illustrates how a binary route can be determined based on the source and destination binary addresses in accordance with some embodiments described in this disclosure. A binary route from a source node to a destination node can be determined as follows. First, the longest common prefix in the binary addresses of the source and destination nodes can be removed to obtain a source remnant string (SRS) and a destination remnant string (DRS), respectively. For example, as shown in FIG. 1B, the common prefix from the binary address of nodes S and D can be removed to obtain SRS 106 and DRS 108. Next, the SRS can be reversed, then complemented, and then the rightmost bit in the resulting bit string can be further complemented to obtain a first bit string. In some embodiments (e.g., embodiments in which each 1×2 node is fully bidirectional), the operation of further complementing the already complemented string can be skipped. For example, performing these operations on SRS 106 results in bit string 110. The leftmost bit in the DRS can then be removed to obtain a second bit string. For example, removing the leftmost bit in DRS 108 results in bit string 112. Finally, the first bit string and the second bit string can be concatenated to obtain the binary route. For example, bit strings 110 and 112 can be concatenated to obtain binary route 114.

FIG. 1C illustrates how a packet can be routed in a binary tree based on a binary route in accordance with some embodiments described in this disclosure. The binary route can start at the source node, e.g., node Sin FIG. 1C. At each hop, the next bit in the binary route can be read, and the packet can be forwarded accordingly (in the example shown in FIG. 1C, the binary route is read from left to right). Each internal node (i.e., a node that is not a root node or a leaf node) in the binary tree has three edges. Whenever a packet comes in on an edge, the other two edges can be labeled “left” and “right” depending on their relative positions to the edge on which the packet arrived. In the example shown in FIG. 1C, if the bit is a “0,” the packet can be forwarded on the right edge, and if the bit is a “1,” the packet can be forwarded on the left edge. For example, if a packet starts at node S with binary route 114, the packet will be routed to node D along path 116 shown in FIG. 1C using a dotted line.

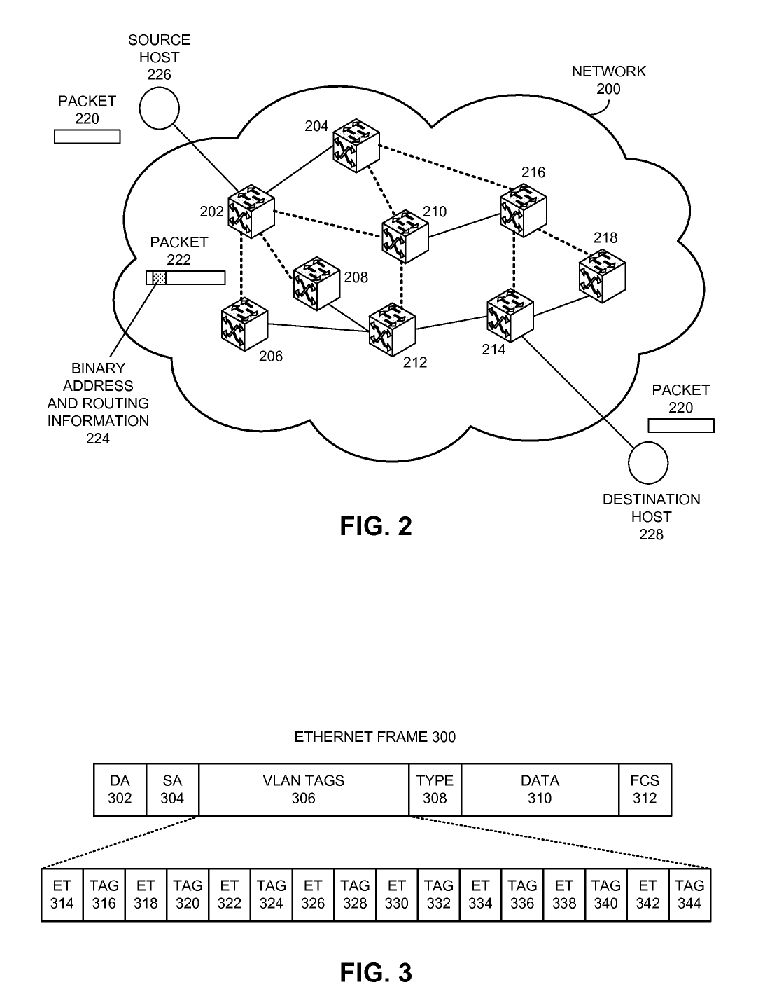

An Example of a Network and a Packet FIG. 2 illustrates how a packet can be forwarded within a network using binary information stored in the VLAN tags in accordance with some embodiments described in this disclosure. Network 200 may include nodes 202-218 that are coupled in a mesh topology. Each node can be a switch-router that is capable of forwarding packets based on a binary tree. A binary tree rooted at node 204 may be embedded on the mesh topology as shown by the dotted lines in FIG. 2. Packet 220 may be received at ingress node 202 from source host 226, and may be destined for destination host 228 that is coupled with egress node 214. Packet 220 may include a source address associated with source host 226 and a destination address associated with destination host 228. Packet 220 may also include VLAN tags. In some embodiments, packet 220 may include MPLS labels.

Ingress node 202 can use the source and destination addresses and any VLAN tags in packet 220 to determine binary address and routing information 224. Binary address and routing information 224 may be stored in header fields that are added to packet 220 to obtain packet 222. Packet 222 can then be forwarded in network 200 based on binary address and routing information 224 until packet 222 reaches egress node 214. Egress node 214 can then remove binary address and routing information 224 from packet 222 to obtain packet 220, and forward packet 220 to destination host 228.

In some embodiments, binary and source routing is implemented using a network protocol that facilitates the inclusion of binary routing and source routing, but which is also backward compatible with a majority of existing networks. Specifically, Carrier Ethernet advances—both Provider-Backbone-Bridging-Traffic Engineering (PBB-TE and Multi-Protocol Label Switching-Traffic Profile (MPLS-TP)—use tags or labels to differentiate services, accord priorities as well as create demarcation between customers and the provider. Some embodiments use PBB-TE, an approach in which spanning tree protocol is switched off and MAC (Media Access Control) address learning is disabled to create Ethernet Switched Paths (ESPs).

PBB-TE allows new VLAN tags to be defined. Some embodiments described herein use four types of VLAN tags: (1) the ARTAG (address-route tag), (2) the GTAG (granularity tag), (3) the TTAG (the type tag), and (4) the WTAG (window tag). The first three are used for forwarding packets, while the last tag (WTAG) is used for mapping TCP functions. Note that these tags may or may not be part of a standard.

In some embodiments of the present invention, packets are forwarded in the network based on the binary tree information stored in the above-mentioned VLAN tags. Unlike some conventional networks, source and destination addresses that are present in the packet when the packet is received at the ingress node are not used for forwarding the packet at each hop in the network.

FIG. 3 illustrates an example of a packet format in accordance with some embodiments described in this disclosure. Ethernet packet 300 can include destination address 302, source address 304, VLAN tags 306, protocol type 308, data 310, and frame check sequence 312. Destination address 302 and source address 304 are Ethernet MAC addresses. Protocol type 308 indicates the type of payload that is being carried in data 310. Destination address 302 and source address 304 are not used for forwarding the Ethernet packet within the network. Forwarding within the network is based on the binary tree addresses and routing information stored in VLAN tags 306.

VLAN tags 306 can include pairs of tag protocol identifiers and tags. For example, VLAN tags 306 can include tag protocol identifiers 314, 318, 322, 326, 330, 334, 338, and 342, and tags 316, 320, 324, 328, 332, 336, 340, and 344. A tag protocol identifier indicates the type of tag that follows the tag protocol identifier.

At least some of the tags shown in FIG. 3 may store information related to binary addresses or routes. If the information related to a binary address or route cannot be stored in a single tag, then it may be stored over multiple tags. In some embodiments, tag 316 can store a TTAG, tag 320 can store a source-ARTAG (S-ARTAG), tags 324 and 328 can store route-ARTAGs (R-ARTAGs), tag 332 can store a GTAG, tag 336 can store a WTAG, tag 340 can store a service provider tag, and tag 344 can store a customer tag.

A TTAG can be used to differentiate the type of the packet, e.g., to differentiate between data packets and control packets. This differentiation can be based on the unique Ethertype embedded in the TTAG. The S-ARTAG can contain the address of the node (the binary route from the root) while the R-ARTAG can contain the binary route from the source node to the destination node. If the binary string that represents the source address or binary route is more than 12-bits (which is the length of a VLAN identifier), then multiple S-ARTAGs or R-ARTAGs can be used to carry the source address or binary route.

The R-ARTAG can be computed at the ingress node, and some of its bits can be updated at intermediate nodes, as the packet makes its way to the destination. Specifically, the R-ARTAG can be created dynamically for a particular source-destination pair, while the S-ARTAG can be static for each node in the network.

If the binary string depicting the route exceeds 12 bits (the size of a VLAN identifier), then multiple R-ARTAGs can be stacked. Recall that each node uses a few bits in the R-ARTAG to determine how to forward the packet. The three-bit QoS (quality of service) field and the one-bit CFI (canonical form identifier) field in the tag can be used to indicate the starting location of the bits in the R-ARTAG that a node needs to inspect to determine how to forward the packet. Initially, the four bits (three QoS bits and one CFI bit) can be set to 0000, and at each intermediate node that has N ports, the value of the 4-bits can be incremented by ┌log₂N┐. When the value of these four bits reaches 1100, the R-ARTAG is no longer considered for forwarding decisions, and the node starts using bits in the next R-ARTAG until the QoS and CFI bits of the next R-ARTAG reach 1100. In this manner, each node identifies the set of ┌log₂N┐ bits that are needed to perform forwarding at the node, and forwards the packet accordingly. R-ARTAGs whose QoS and CFI bits are equal to 1100 may be discarded. The S-ARTAG, on the other hand, are not altered or discarded unless a dynamic topology change occurs in the network.

The GTAG uses 9-bits in its protocol identifier to denote granularity of the connection. The WTAG or window tag can be used for error recovery purposes and for implementing multi-point TCP functions.

### Switch-Router Architecture

A source host coupled to the network can either support a kernel patch that feeds n-ary address and/or routing information to the MAC layer or sends standard Ethernet packets to the switch-router. In the latter case, the incoming packet can be processed by a Thin Ethernet Logical Layer (TELL), which inserts one or more tags that carry n-ary address and/or routing information, thereby converting the incoming packet into a packet that can be processed and forwarded based on the n-ary information stored in the packet header. To this end, the TELL maintains a table that has three columns: a protocol type, an address, and an S-ARTAG. In some embodiments, the TELL may maintain a table that has two columns: an address and an S-ARTAG. The TELL enables the switch-router to map the address in the incoming packet to a corresponding S-ARTAG. The S-ARTAG can then be used to forward the packet to the egress node in the network. For example, in one of the entries of the TELL table, the protocol type can be Ethernet, the address can be an Ethernet MAC address, and the S-ARTAG can be the n-ary address of the node or host that is associated with the Ethernet MAC address.

A switch-router may or may not have the entire network-wide address database. The complete database of mappings can be stored in one or more servers, e.g., an Ethernet Nomenclature System (ENS) server, which is accessible to every switch-router. The ENS server can enable a switch-router to determine the binary address associated with a destination node whose binary address is not stored in the local TELL table. In some embodiments, the size of the TELL table in a switch-router can be K, and the TELL table may use a cache replacement policy to update entries in the TELL table. For example, in one embodiment, the TELL table can be updated using an LRU (least recently used) replacement policy. Some embodiments may use multiple ENS servers which store the network wide mapping in a distributed fashion.

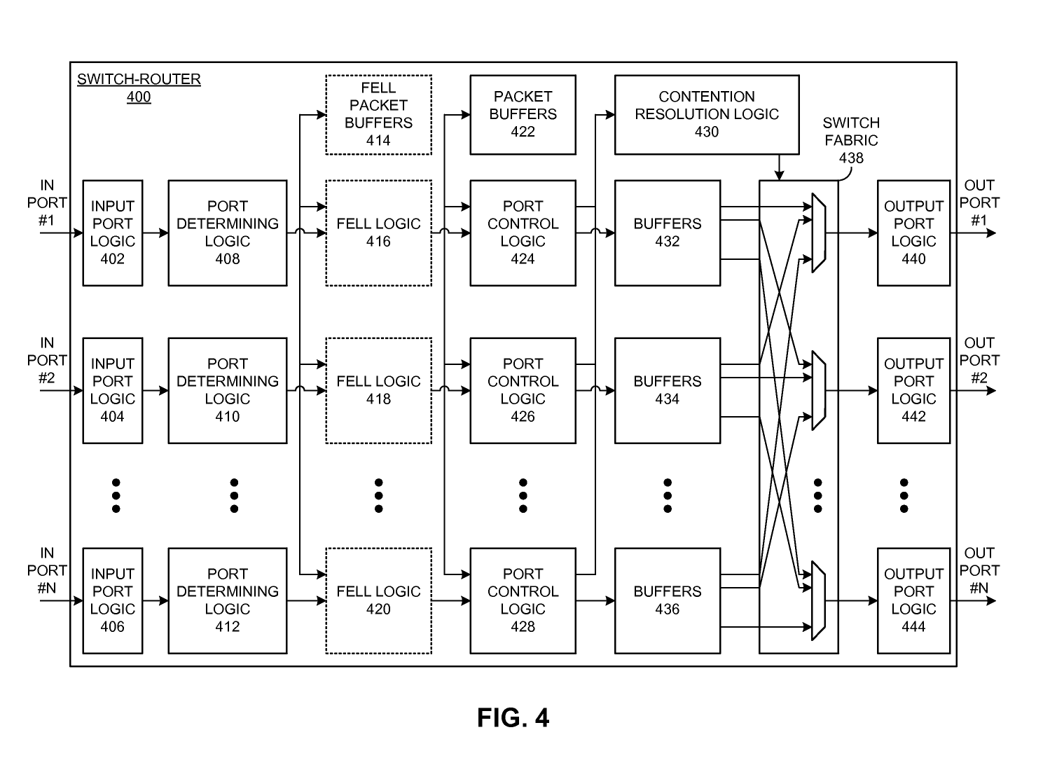

FIG. 4 illustrates a system, e.g., a switch-router, in accordance with some embodiments described in this disclosure. In conventional switches and routers, latency is induced due to contention resolution and performing forwarding table lookups. If the packet has n-ary routing information, the switch-router shown in FIG. 4 does not need to perform any forwarding table lookups. However, the issue of contention resolution and head-of-line (HOL) blocking still needs to be addressed.

Implementing a completely non-blocking virtual input/output queuing switch fabric may not be tractable due to its size. If the architecture is not completely non-blocking, packets may be dropped due to contention. In some embodiments, the switch-router includes a contention resolution mechanism based on a scheme that is memory conserving while deploying a very-fast memory interaction mechanism. This mechanism is referred in this disclosure as distributed lumped buffer scheduling (DLBS).

Switch-router 400 can include a set of bidirectional ports (e.g., port #1 through port #N), input port logic 402-206, port determining logic 408-412, Fat Ethernet Logical Layer (FELL) logic 416-420, FELL packet buffers 414, port control logic 424-428, packet buffers associated with the port control logic 422, buffers 432-436, contention resolution logic 430, switch fabric 438, and output port logic 440-444. FELL logic 416-420 and FELL packet buffers 414, which are shown using dotted lines, can be optional components of switch-router 400. Specifically, FELL logic 416-420 and FELL packet buffers 414 may be included in switch-router 400 if switch-router 400 needs to implement transport layer functionalities, e.g., window based flow control. Specifically, FELL logic 416-420 and FELL packet buffers 414 may combine the functionality of a link layer (e.g., Ethernet MAC layer), a network layer (e.g., IP layer), and a transport layer (e.g., UDP (User Datagram Protocol) or TCP (Transmission Control Protocol)) into a single layer. For example, FELL logic 416-420 can create a soft-buffer for each TCP (Transmission Control Protocol) or UDP (User Datagram Protocol) socket, and schedule data from the soft-buffer to implement a flow control mechanism, e.g., a sliding window flow control mechanism. In conventional networking stacks, a user level application can open a socket with a transport layer and use the socket to send and receive data. In a conventional system, when a user application sends or receives data through a socket, the data moves through the different layers in the networking stack, which may create inefficiencies. In contrast, in embodiments of the present invention that include FELL logic 416-420 and FELL packet buffers 414, a user level application can open a socket directly with the FELL layer (instead of a transport layer) and use the socket to send and receive data.

In some embodiments, the bits in the binary address of a packet that are relevant to the current node are resolved by input port logic 402-406. Once the appropriate bits in the binary tag have been identified, switch-router 400 can check whether the output buffer corresponding to the output port is free. If so, the packet can be forwarded using an express path, to the corresponding output port in a single clock cycle, thus achieving fast switching and/or routing.

When included in switch-router 400, FELL logic 416-420 can perform processing that is analogous to TELL processing performed by TELL logic 506, but may be more process intensive and may involve processing packets that contain information beyond ARTAGs.

Once the output port for a packet has been determined, the packet can be provided to the output port by a sub-system that comprises port control logic 424-428, packet buffers 422, contention resolution logic 430, buffers 432-436, and switch fabric 438. Specifically, if the output buffer corresponding to the output port is not free, the packet is either stored in a close-to-the-switch cache (e.g., buffers 432-436) or if the cache is occupied, then the packet is stored in an off-chip memory (e.g., packet buffers 422).

The communication between the off-chip memory (e.g., packet buffers 422) and other components (e.g., port control logic 424-428) in switch-router 400 may have a large latency, especially since the bandwidth of the communication channel is shared between the 2×N ports (for concurrent read and write) in addition to access time latencies of the memory. Some embodiments alleviate this problem by partitioning the memory into collocated buffers that are lumped together, and which can be fetched together using a lumped table approach.

Input port logic 402-206 receives packets. In some embodiments, input port logic 402-206 can receive packets from the Ethernet PHY layer by supporting the GMII (Gigabit Medium Independent Interface) or XAUI (10 Gigabit Attachment Unit Interface) thus enabling correct reception of packets from the PHY (which may be located outside switch-router 400). In some embodiments, input port logic 402-206 converts the received packets into a format that is compatible with other components in switch-router 400. For example, input port logic 402-206 may add a local time-stamp and data-valid bits to the received packets.

Port determining logic 408-412 determines if an incoming packet includes n-ary address and/or routing information or whether n-ary address and/or routing information needs to be added to the packet. If the packet does not contain n-ary address and/or routing information, then the packet is sent to TELL logic, which can add the n-ary address and/or routing information, or drop the packet if the header information in the packet cannot be mapped to n-ary address and/or routing information. As explained above, the TELL logic may maintain a TELL table that has three columns: a protocol type, an address, and an S-ARTAG. The TELL logic enables the switch-router to map the address in the incoming packet to a corresponding S-ARTAG. In some embodiments, the size of the TELL table in a switch-router can be K, and the TELL table may use any cache replacement policy to update entries in the TELL table. For example, in one embodiment, the TELL table can be updated using an LRU (least recently used) policy. If a packet arrives whose protocol identifier is not part of the TELL table, the node can communicate with the ENS server and fetch the corresponding n-ary address and/or routing information.

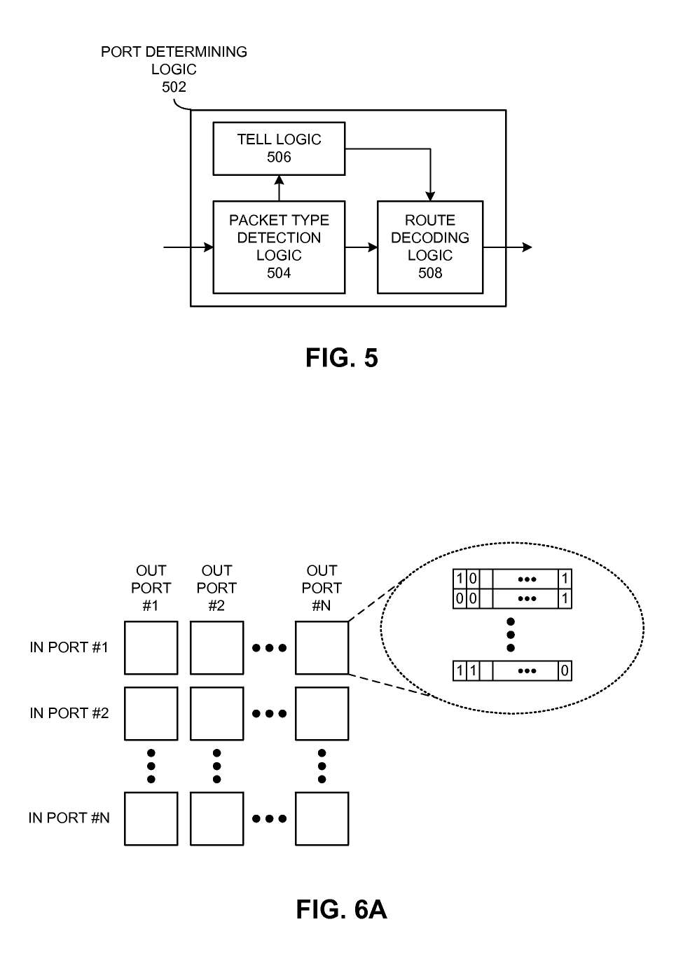

FIG. 5 illustrates a port determining logic block in accordance with some embodiments described in this disclosure.

Port determining logic 502 can include TELL logic 506, packet type detection logic 504, and route decoding logic 508. Packet type detection logic 504 can determine whether a packet has n-ary address and/or routing information. If so, packet type detection logic 504 can provide the packet to route decoding logic 508. If the packet does not have n-ary address and/or routing information, packet type detection logic 504 can provide the packet to TELL logic 506. TELL logic 506 can then add the appropriate n-ary address and/or routing information to the packet and provide the packet to route decoding logic 508. Route decoding logic 508 can use the n-ary address and/or routing information in the packet to determine the output port over which the packet is to be forwarded.

Specifically, if the packet is a control packet, then route decoding logic 508 can send the packet to a local port for management purposes. On the other hand, if the packet is a data packet, then route decoding logic 508 can decode the R-ARTAGs in the packet. In particular, route decoding logic 508 can read the active R-ARTAG (i.e., the one that corresponds to a non-zero marker) to obtain the n-ary address and/or routing information. Next, route decoding logic 508 can read the appropriate set of ┌log₂N┐ bits. This information can then be used by route decoding logic 508 for locating the appropriate output port. Route decoding logic 508 can also increment the non-zero marker in the R-ARTAG so that the switch-router at the next hop can extract the appropriate bits in the R-ARTAG.

If route decoding logic 508 determines that the output port buffer for the packet is not free, switch-router 400 can use the DLBS scheme to resolve the contention. Specifically, a buffer (e.g., buffers 432) can be provided for each port. The buffer may have limited storage space, e.g., it may have space for eight maximum transmission units (MTUs). If the packet fits into this buffer then it is stored here. If however, the packet cannot be fit in the buffer, it has to be stored in the off-chip memory (e.g., packet buffers 414). One of the problems with the interaction between off-chip memory and on-chip components can be the limited amount of bandwidth that is available for the interaction. This problem can be alleviated by using a lumped table as explained below.

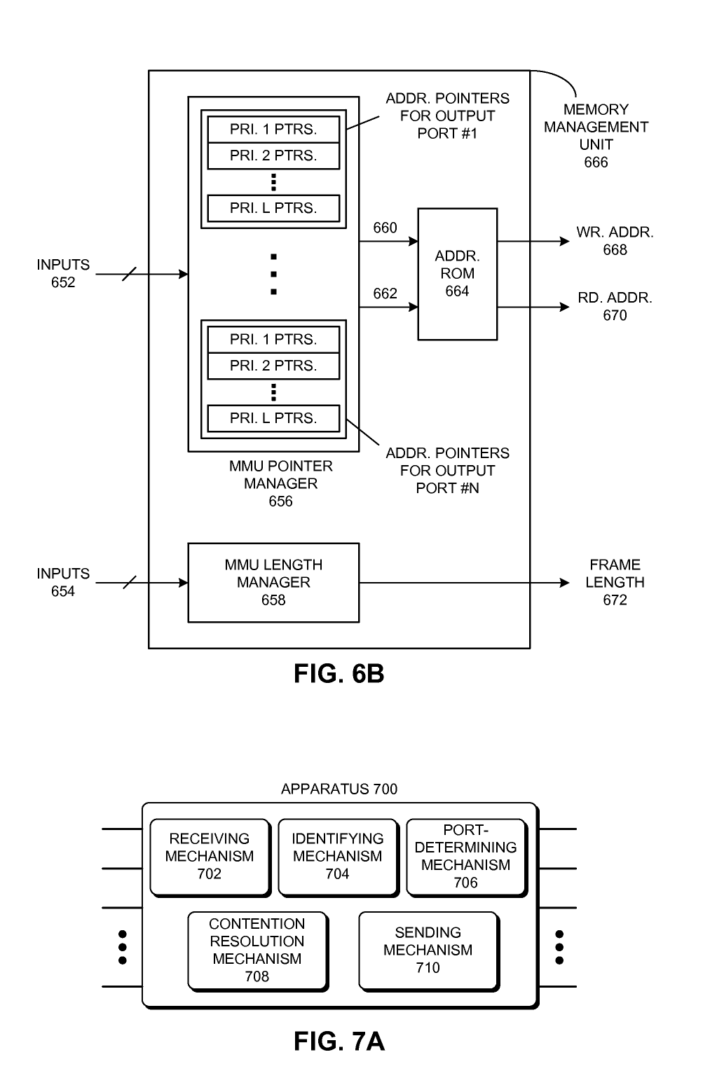

FIG. 6A illustrates how buffers for ports can be stored in a lumped table in accordance with some embodiments described in this disclosure.

In some embodiments of the present invention, the buffers for all the ports are lumped together in N×N memory blocks as shown in FIG. 6. Each memory block corresponds to an input-output port combination (and hence, there are N² distinct memory blocks). Each memory block has a number of MTU sized cells marked with different priority levels. A zero-value in the lumped table, corresponding to a particular cell, indicates that no packet is being stored at the corresponding location. A one-value implies that the cell is currently occupied. Whenever an output port is free, the contention resolution block examines the lumped table and fetches the packet that is currently in the memory with the highest priority. The fetched packet is sent directly to the output port, or if a new packet arrives that causes contention, then the fetched packet is temporarily stored in buffers 432-436 before transmission. In some embodiments, each memory block in the off-chip memory module can include storage space for each priority levels. Specifically, the storage space for a particular priority level can store a certain number of packets of that priority level.

FIG. 6B illustrates a memory management unit (MMU) that can be used to access the lumped memory buffer in accordance with some embodiments described in this disclosure.

MMU 666 can include MMU pointer manager 656, MMU length manager 658, and address read-only memory (ROM) 664. MMU pointer manager 656 can store read and write pointers for each priority level for each memory block in the lumped buffer. As shown in FIG. 6B, MMU pointer manager 656 can store pointers for priority levels 1 through L for output ports 1 through N.

MMU pointer manager 656 can receive inputs 652, which can include an output port number on which the packet is being sent, a priority level of the packet, a read request pointer which identifies a buffer from which data is to be read, a write request pointer that identifies a buffer to which data is to be written, an increment read pointer signal which indicates that a read pointer is to be incremented, and a increment write pointer signal which indicates that a write pointer is to be incremented. Based on inputs 652, MMU pointer manger 656 can generate write address pointer 660 and read address pointer 662, which can be used to look up write address 668 and read address 670, respectively. Write address 668 and read address 670 can be used to access a starting memory address in the lumped memory buffer where data is to be written or from which data is to be read.

MMU length manager 658 can receive inputs 654, which can include an output port number on which the packet is being sent, a priority level of the packet, an update length, and a frame write length. Based on inputs 654, MMU length manager 658 can generate frame length 672 which can be used to access data stored in a block of memory addresses which start at the memory address specified by write address 668 or read address 670.

Switch fabric 438 can be a fully non-blocking virtual output queued switch fabric. Switch fabric 438 can be visualized as having a multiplexer per output port. Buffers 432-436 can serve as the input stage for the multiplexers. The connection between the input and output port can be setup by contention resolution logic 430. Contention resolution logic 430 can generate the select signals for the output port multiplexers based on the priority of the incoming packets and availability of the output port.

Output port logic 440-444 can serve two functions. First, at the egress node, output port logic 440-444 can remove the tags that were added at the ingress node (e.g., R-ARTAG). Note that if the egress switch is coupled with a device that can process R-ARTAGs, S-ARTAGs, etc., then the tags may not need to be removed. Second, output port logic 440-444 can interface with the PHY (physical layer) and implement a GMII or XAUI interface.

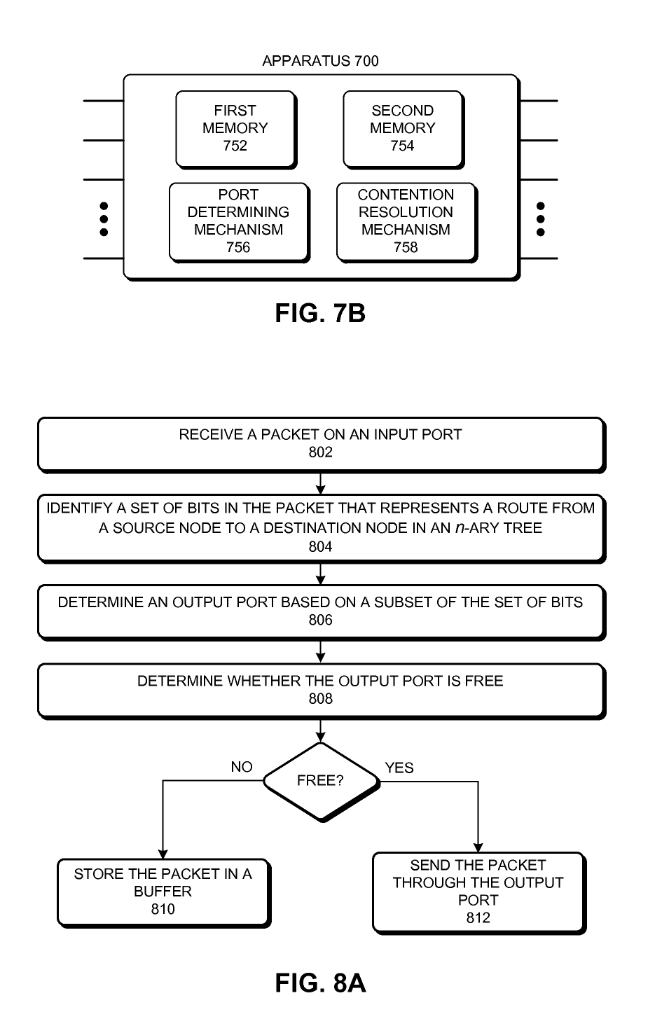

FIG. 7A illustrates an apparatus in accordance with some embodiments described in this disclosure.

Apparatus 700 can include a plurality of mechanisms which may communicate with one another via a communication channel, e.g., a bus. One or more mechanisms in apparatus 700 may be realized using one or more field-programmable gate arrays (FPGAs) or application-specific integrated circuits (ASICs).

In some embodiments, apparatus 700 is a switch-router which includes receiving mechanism 702, identifying mechanism 704, port-determining mechanism 706, contention resolution mechanism 708, and sending mechanism 710.

Receiving mechanism 702 may be configured to receive a packet on an input port. In some embodiments, receiving mechanism 702 may correspond to input port logic 402-406 shown in FIG. 4. In some embodiments, apparatus 700 may have N bidirectional ports, i.e., each bidirectional port may include an input port and an output port.

In some embodiments, apparatus 700 may include a type-determining mechanism configured to determine whether the packet is a control packet, and sending mechanism 710 may be configured to send the packet to a management port if the packet is determined to be a control packet by the type-determining mechanism. In some embodiments, the type-determining mechanism can correspond to packet type detection logic 504 shown in FIG. 5.

In some embodiments, apparatus 700 may include a format-determining mechanism configured to determine whether the packet conforms to a format that includes the set of bits that represents the route from the source node to the destination node in the n-ary tree. Apparatus 700 may further include an adding mechanism configured to add the set of bits if the packet does not conform to the n-ary tree based packet format. For example, if the packet does not have R-ARTAGs, S-ARTAGs, etc., then the adding mechanism can add the appropriate set of R-ARTAGs, S-ARTAGs, etc., to the packet. In some embodiments, the format-determining mechanism may correspond to packet type detection logic 504 shown in FIG. 5, and the adding mechanism may correspond to TELL logic 506 shown in FIG. 5.

Identifying mechanism 704 may be configured to identify a set of bits in the packet that represents a route from a source node to a destination node in an n-ary tree. Port-determining mechanism 706 may be configured to determine an output port based on a subset of the set of bits. The number of bits in the subset of the set of bits can be ┌log₂N┐, wherein N is the number of output ports. In some embodiments, the packet can be an Ethernet packet, and the set of bits can be stored in one or more VLAN tags. The location of the subset of the set of bits in the one or more VLAN tags can be encoded using the three-bit QoS fields and the one-bit CFI fields in the VLAN tags. In some embodiments, the packet can be an MPLS or MPLS-TP packet. In some embodiments, identifying mechanism 704 and port-determining mechanism 706 may correspond to port determining logic 408-412.

Contention resolution mechanism 708 may be configured to determine whether the output port is free. Sending mechanism 710 may be configured to store the packet in a buffer if the output port is not free, and send the packet through the output port if the output port is free. In some embodiments, contention resolution mechanism 708 may correspond to contention resolution logic 430 shown in FIG. 4. Sending mechanism 710 may correspond to port control logic 424-428, buffers 432-436, switch fabric 438, and output port logic 440-444.

In some embodiments, apparatus 700 may include N×N memory blocks, wherein N is the number of output ports. Each memory block can be associated with an input port and an output port, and each memory block can include buffers for storing packets that are received on the associated input port and which are destined for the associated output port. In some embodiments, the N×N memory blocks may correspond to the memory blocks shown in FIG. 6.

FIG. 7B illustrates an apparatus in accordance with some embodiments described in this disclosure.

Apparatus 750 can include a plurality of mechanisms which may communicate with one another via a communication channel, e.g., a bus. One or more mechanisms in apparatus 750 may be realized using one or more field-programmable gate arrays (FPGAs) or application-specific integrated circuits (ASICs).

In some embodiments, apparatus 750 is a switch-router which includes input ports to receive packets, output ports to send packets, first memory 752, second memory 754, port-determining mechanism 756, and contention resolution mechanism 758.

First memory 752 may have a lower latency than second memory 754. First memory 752 can correspond to local on-chip buffers 432-436. Second memory 754 can correspond to global off-chip packet buffers 422. Port determining mechanism 756 can be configured to determine an output port for a packet. Port determining mechanism 756 can correspond to port determining logic 408-412.

Contention resolution mechanism 758 can include contention resolution logic 430, port control logic 424-428, and switch fabric 438. Contention resolution mechanism 758 can be configured to provide the packet to the output port if the output port is free. Contention resolution mechanism 758 can determine whether the output port is busy and whether space is available in the first memory to store the packet. If the output port is busy and space is available in the first memory, contention resolution mechanism 758 can store the packet in the first memory. However, if the output port is busy and space is not available in the first memory to store the packet, contention resolution mechanism 758 can then determine whether a lower-priority packet is currently stored in the first memory that can be pre-empted by the received packet. If so, contention resolution mechanism 758 can pre-empt the lower-priority packet by moving the lower-priority packet to the second memory, and storing the received packet in the first memory. However, if the output port is busy, space is not available in the first memory to store the packet, and there are no lower-priority packets in the first memory that can be pre-empted, contention resolution mechanism 758 can store the packet in the second memory.

Once the packet is stored in the second memory, contention resolution mechanism 758 can either provide the packet to the output port or move it back to the first memory. Specifically, contention resolution mechanism 758 can determine whether the output port is busy and whether there is space in the first memory to store the packet. If output port is free and the first memory does not contain any packets, contention resolution mechanism 758 can provide the packet to the output port. On the other hand, if the output port is busy, but the first memory has space for storing the packet, contention resolution mechanism 758 can move the packet to the first memory so that it can subsequently be sent out of the output port.

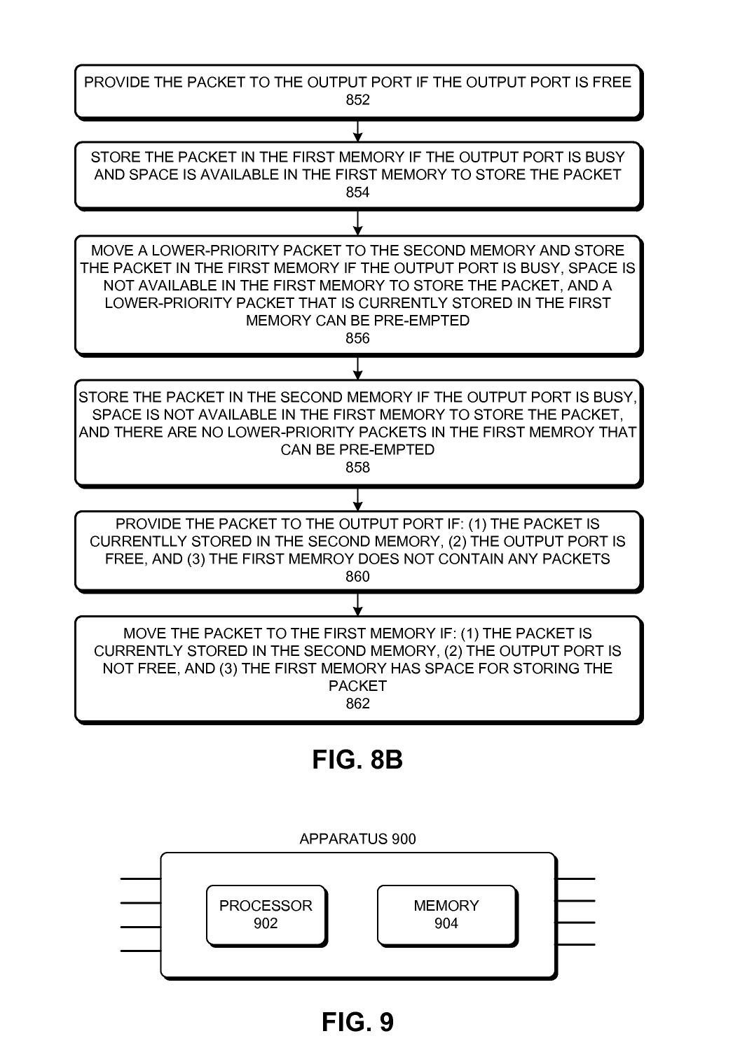

FIG. 8A presents a flowchart that illustrates a process for forwarding packet in accordance with some embodiments described in this disclosure.

The process can begin by receiving a packet on an input port of a switch-router (operation 802). Next, the switch router can identify a set of bits in the packet that represents a route from a source node to a destination node in an n-ary tree (operation 804). The switch-router can then determine an output port based on a subset of the set of bits (operation 806). Next, the switch-router can determine whether the output port is free (operation 808). If the output port is not free, the switch-router can store the packet in a buffer (operation 810). The buffer can be a local on-chip buffer or a global off-chip lumped buffer. On the other hand, if the output port is free, the switch-router can send the packet through the output port (operation 812).

FIG. 8B presents a flowchart that illustrates a process for resolving contentions in accordance with some embodiments described in this disclosure.

The system can provide the packet to the output port if the output port is free (operation 852). The system can store the packet in the first memory if the output port is busy and space is available in the first memory to store the packet (operation 854). The system can move a lower-priority packet to the second memory and store the packet in the first memory if the output port is busy, space is not available in the first memory to store the packet, and a lower-priority packet that is currently stored in the first memory can be pre-empted (operation 856). The system can store the packet in the second memory if the output port is busy, space is not available in the first memory to store the packet, and there are no lower-priority packets in the first memory that can be pre-empted (operation 858). The system can provide the packet to the output port if: (1) the packet is currently stored in the second memory, (2) the output port is free, and (3) the first memory does not contain any packets (operation 860). The system can move the packet to the first memory if: (1) the packet is currently stored in the second memory, (2) the output port is not free, and (3) the first memory has space for storing the packet (operation 862).

FIG. 9 illustrates an apparatus in accordance with some embodiments described in this disclosure.

Apparatus 900 can include one or more processors and one or more non-transitory processor-readable storage media. Specifically, apparatus 900 can include processor 902 (e.g., a network processor) and memory 904. Apparatus 900 can also include one or more packet buffers, e.g., a fast packet buffer (e.g., a memory with a relatively low latency) and a slow packet buffer (e.g., a memory with a relatively high latency). Processor 902 may be capable of accessing and executing instructions stored in memory 904. For example, processor 902 and memory 904 may be coupled by a bus. Memory 904 may store instructions that when executed by processor 902 cause apparatus 900 to perform the process illustrated in FIGS. 8A and/or 8B.

Specifically, memory 904 may store instructions for receiving a packet on an input port, identifying a set of bits in the packet that represents a route from a source node to a destination node in an n-ary tree, determining an output port based on a subset of the set of bits, determining whether the output port is free, storing the packet in a local on-chip or a global off-chip lumped buffer if the output port is not free, and sending the packet through the output port if the output port is free.

The data structures and code described in this disclosure can be partially or fully stored on a non-transitory computer-readable storage medium and/or a hardware mechanism and/or a hardware apparatus. A computer-readable storage medium includes, but is not limited to, volatile memory, non-volatile memory, magnetic and optical storage devices such as disk drives, magnetic tape, CDs (compact discs), DVDs (digital versatile discs or digital video discs), or other non-transitory media, now known or later developed, that are capable of storing code and/or data.

Embodiments described in this disclosure can be implemented in ASICs, FPGAs, dedicated or shared processors, and/or other hardware modules or apparatuses now known or later developed. Specifically, the methods and/or processes may be described in a hardware description language (HDL) which may be compiled to synthesize register transfer logic (RTL) circuitry which can perform the methods and/or processes. Embodiments described in this disclosure may be implemented using purely optical technologies. The methods and processes described in this disclosure can be partially or fully embodied as code and/or data stored in a computer-readable storage medium or device, so that when a computer system reads and/or executes the code and/or data, the computer system performs the associated methods and processes.

The foregoing descriptions of embodiments of the present invention have been presented only for purposes of illustration and description. They are not intended to be exhaustive or to limit the present invention to the forms disclosed. Accordingly, many modifications and variations will be apparent to practitioners having ordinary skill in the art. Additionally, the above disclosure is not intended to limit the present invention. The scope of the present invention is defined by the appended claims.

What is claimed is:

1. An apparatus, comprising:
input ports to receive packets;
output ports to send packets;
a port determining mechanism to determine an output port for a packet;
a first memory and a second memory, wherein the first memory has a lower latency than the second memory; and
a contention resolution mechanism to:
provide the packet to the output port if the output port is free;
in response to determining that the output port is busy and space is available in the first memory to store the packet, store the packet in the first memory;
in response to determining that the output port is busy, space is not available in the first memory to store the packet, and a lower-priority packet having a lower priority than the packet is currently stored in the first memory, move the lower-priority packet to the second memory, and store the packet in the first memory;
in response to determining that the output port is busy, space is not available in the first memory to store the packet, and a lower-priority packet having a lower priority than the packet is not currently stored in the first memory, store the packet in the second memory;
in response to determining that the output port is free and the first memory does not contain any packets, provide the packet, if currently stored in the second memory, to the output port; and
in response to determining that the output port is not free and the first memory has space for storing the packet, move the packet, if currently stored in the second memory, to the first memory.

2. The apparatus of claim 1, wherein the port determining mechanism is configured to:
identify a set of bits in the packet, wherein the set of bits represents a route from a source node to a destination node in an n-ary tree; and
determine the output port based on a subset of the set of bits.

3. The apparatus of claim 2, wherein the apparatus has N input ports and N output ports, wherein the second memory comprises N×N memory blocks, wherein each memory block is associated with an input port and an output port, and wherein each memory block includes buffers for storing packets that are received on the input port associated with the memory block and which are destined for the output port associated with the memory block.

4. The apparatus of claim 2, wherein the packet is an Ethernet packet, wherein the set of bits are stored in one or more VLAN (Virtual Local Area Network) tags, and wherein a location of the subset of the set of bits in the one or more VLAN tags is encoded using three-bit QoS (quality of service) fields and one-bit CFI (canonical form identifier) fields in the one or more VLAN tags.

5. The apparatus of claim 2, wherein the packet is an MPLS (Multi-Protocol Label Switching) packet, wherein the set of bits are stored in one or more MPLS labels, and wherein a location of the subset of the set of bits in the one or more MPLS labels is encoded in specific portion of each MPLS label.

6. The apparatus of claim 2, further comprising:
a format-determining mechanism configured to determine whether the packet conforms to a format that includes the set of bits that represents the route from the source node to the destination node in the n-ary tree; and
an adding mechanism configured to add the set of bits if the packet does not conform to the format.

7. An apparatus, comprising:
input ports to receive packets;
output ports to output packets;
a first memory and a second memory, wherein the first memory has a lower latency than the second memory;
a processor; and
a non-transitory processor-readable storage medium storing instructions that are capable of being executed by the processor, the instructions comprising:
instructions to determine an output port for a packet;
instructions to provide the packet to the output port if the output port is free;
instructions to, in response to determining that the output port is busy and space is available in the first memory to store the packet, store the packet in the first memory;
instructions to, in response to determining that the output port is busy, space is not available in the first memory to store the packet, and a lower-priority packet having a lower priority than the packet is currently stored in the first memory, move the lower-priority packet to the second memory, and store the packet in the first memory;
instructions to, in response to determining that the output port is busy, space is not available in the first memory to store the packet, and a lower-priority packet having a lower priority than the packet is not currently stored in the first memory, store the packet in the second memory;
instructions to, in response to determining that the output port is free and the first memory does not contain any packets, provide the packet, if currently stored in the second memory, to the output port; and
instructions to, in response to determining that the output port is not free and the first memory has space for storing the packet, move the packet, if currently stored in the second memory, to the first memory.

8. The apparatus of claim 7, wherein the instructions to determine the output port for the packet include:
instructions to identify a set of bits in the packet, wherein the set of bits represents a route from a source node to a destination node in an n-ary tree; and
instructions to determine the output port based on a subset of the set of bits.

9. The apparatus of claim 8, wherein the apparatus has N input ports and N output ports, wherein the second memory comprises N×N memory blocks, wherein each memory block is associated with an input port and an output port, and wherein each memory block includes buffers for storing packets that are received on the input port associated with the memory block and which are destined for the output port associated with the memory block.

10. The apparatus of claim 8, wherein the packet is an Ethernet packet, wherein the set of bits are stored in one or more VLAN (Virtual Local Area Network) tags, and wherein a location of the subset of the set of bits in the one or more VLAN tags is encoded using three-bit QoS (quality of service) fields and one-bit CFI (canonical form identifier) fields in the one or more VLAN tags.

11. The apparatus of claim 8, wherein the packet is an MPLS (Multi-Protocol Label Switching) packet, wherein the set of bits are stored in one or more MPLS labels, and wherein a location of the subset of the set of bits in the one or more MPLS labels is encoded in specific portion of each MPLS label.

12. The apparatus of claim 8, the instructions further comprising:
instructions to determine whether the packet conforms to a format that includes the set of bits that represents the route from the source node to the destination node in the n-ary tree; and
instructions to add the set of bits if the packet does not conform to the format.

13. A method, comprising:
determining an output port for a packet;
providing the packet to the output port if the output port is free;
in response to determining that the output port is busy and space is available in a first memory to store the packet, storing the packet in the first memory, wherein the first memory has a lower latency than a second memory;
in response to determining that the output port is busy, space is not available in the first memory to store the packet, and a lower-priority packet having a lower priority than the packet is currently stored in the first memory,
moving the lower-priority packet to the second memory, and
storing the packet in the first memory;
in response to determining that the output port is busy, space is not available in the first memory to store the packet, and a lower-priority packet having a lower priority than the packet is not currently stored in the first memory, storing the packet in the second memory;
in response to determining that the output port is free and the first memory does not contain any packets, providing the packet, if currently stored in the second memory, to the output port; and
in response to determining that the output port is not free and the first memory has space for storing the packet, moving the packet, if currently stored in the second memory, to the first memory.

14. The method of claim 13, wherein determining the output port for the packet involves:
identifying a set of bits in the packet, wherein the set of bits represents a route from a source node to a destination node in an n-ary tree; and
determining the output port based on a subset of the set of bits.

15. The method of claim 14, wherein the apparatus has N input ports and N output ports, wherein the second memory comprises N×N memory blocks, wherein each memory block is associated with an input port and an output port, and wherein each memory block includes buffers for storing packets that are received on the input port associated with the memory block and which are destined for the output port associated with the memory block.

16. The method of claim 14, wherein the packet is an Ethernet packet, wherein the set of bits are stored in one or more VLAN (Virtual Local Area Network) tags, and wherein a location of the subset of the set of bits in the one or more VLAN tags is encoded using three-bit QoS (quality of service) fields and one-bit CFI (canonical form identifier) fields in the one or more VLAN tags.

17. The method of claim 14, wherein the packet is an MPLS (Multi-Protocol Label Switching) packet, wherein the set of bits are stored in one or more MPLS labels, and wherein a location of the subset of the set of bits in the one or more MPLS labels is encoded in specific portion of each MPLS label.

18. The method of claim 14, further comprising:
determining whether the packet conforms to a format that includes the set of bits that represents the route from the source node to the destination node in the n-ary tree; and
adding the set of bits if the packet does not conform to the format.
